(19) United States
(12) Patent Application Publication
(10) Pub. No.: US 2017/0131723 A1
(43) Pub. Date: May 11, 2017

(54) CONTROL DEVICE FOR A SPREADING VEHICLE

(71) Applicant: G. LUFFT MESS- UND REGELTECHNIK GMBH, Fellbach-Schmiden (DE)

(72) Inventor: Klaus Hirzel, Stuttgart (DE)

(21) Appl. No.: 15/319,732

(22) PCT Filed: Jun. 16, 2014
(86) PCT No.: PCT/EP2014/062532

§ 371 Date: Dec. 16, 2016

(51) Int. Cl. G05D 1/02; E01H 10/00; G08G 1/01

(52) U.S. Cl. CPC G05D 1/0278; G05D 1/0219; G05D 1/0231; G08G 1/0125; E01H 10/007; G05D 2201/0203

(57) ABSTRACT

The invention relates to a device for controlling the operation of a spreading apparatus of a spreading vehicle (1) for winter road maintenance, comprising a data transmission apparatus (100), which is provided in the spreading vehicle and which is designed to establish a wireless data connection, and which is designed to receive forecast data regarding weather conditions and/or transportation route conditions from a server, in particular via the Internet, an apparatus (101) for detennining transportation route conditions, which is mounted in or on the spreading vehicle and is designed to detennine surface parameters of a transportation route, and a control unit (102), which is designed to receive the forecast data from the data transmission apparatus (100) and to process said forecast data and to control the operation of the spreading apparatus on the basis of the processed forecast data and the determined surface parameters.

### FIELD OF THE INVENTION

The invention relates to a control device for a spreading vehicle for winter road maintenance and in particular the control of a spreading process of a spreading vehicle in consideration of data regarding the weather forecast.

### STATE OF THE ART

Spreading vehicles for winter road maintenance are used for spreading road salt on traffic surfaces for de-icing and/or blunting of traffic routes. Liquid and granulated de-icing materials as well as mixtures of liquid and granulated de-icing materials, in particular salts, and blunting materials such as sand and grit are spread. De-icing salt is often dampened prior to or during the spreading process with a liquid, i.e. the so-called brine, added in an appropriate dose so hat it adheres better to the traffic surfaces and that it is exposed substantially less to the risk of being blown away by the natural wind or the airstream of the spreading vehicle or other vehicles both during as well as after spreading of the road salt. Some winter maintenance service providers increasingly switch to the use of exclusively liquid brine.

The spreading process usually takes place in an electronically controlled way. This means that a spreading process is interrupted via a control system when the spreading vehicle stops for example at a crossroads. The U.S. Pat. No. 6,149,079 A describes a control of the spreading process that controls the conveyor organ of the spreading material and a disperser as a function of the movement of the spreading vehicle. In the DE 31 24 368 A1, a method in which the spreading process is controlled as a function of the velocity of the spreading vehicle is described. The DE 10 2005 012 886 A1 describes a spreading vehicle for winter road maintenance in which a dosage unit controls the spreading process as a function of a predetermined spreading width, spreading density and travel speed.

In spite of different progresses, however, guaranteeing a reliable, time- and spreading material-optimized spreading process for de-icing and blunting of traffic routes has not been successful. For example, delayed de-icing operations or unnecessary dredging of traffic route sections that would also have ensured sufficient adherence of vehicles without de-icing material have been repeatedly occurring issues.

In view of these problems in the state of the art, a purpose of the present invention is to provide a control of a spreading device of a spreading vehicle for winter road maintenance that enables a temporally and spatially optimized de-icing process.

### DESCRIPTION OF THE INVENTION

This problem is solved by a device for controlling the operation of a spreading unit of a spreading vehicle for winter road maintenance according to claim 1. The device comprises a data transmission device (to send and to receive data) that is provided in the spreading vehicle and that is configured to establish a wireless data connection and that is configured to receive forecast data regarding weather and/or traffic route conditions (in particular road conditions) from a server, in particular over the Internet;

a device to determine traffic route conditions that is installed in or on the spreading vehicle and that is configured to determine surface parameters of a traffic route (that is used or to be used in particular by the spreading vehicle; and

a control unit that is configured to receive and to process the forecast data from the data transmission device and to control the operation of the control device on the basis of the processed forecast data and the determined surface parameters.

In this context, traffic routes shall be understood as any routes that are accessible for vehicles, e.g. roads, airfields, taxiways, etc. A known manned spreading vehicle, for example a truck in which the device according to the invention is installed, can be used as a spreading vehicle. The control device of the spreading vehicle can be configured to disperse de-icing material in form of liquid and granulated ice melting materials as well as mixtures of liquid and granulated ice melting materials, in particular of salts, and blunting materials such as sand and grit. The forecast data regarding the traffic route conditions can comprise data on such traffic routes or some of the surface parameters that are determined by the device for the specification of traffic route conditions of the spreading vehicle. These surface parameters include parameters for the surface temperature, moisture, ice thickness, snow thickness, water film thickness, the ice-water ratio, and the freezing temperature of an ice-water mixture, the salt content of an ice-water mixture and the friction coefficient of the traffic route. Weather forecast data can comprise data about the predicted air temperature and precipitation type and quantity.

The data transmission device can be configured to exchange data through a mobile network or a wireless network. The device for determining traffic route conditions can be connected to the data transmission device and/or the control unit for example via a CAN interface or another interface (RS 484 or RS 485) that is typical for passenger cars. In addition, this device can be connected via such an interface to a device for determining the position of the spreading vehicle, for example on the basis of GPS. The control unit can comprise a commercial computer, a CPU unit as well as a permanent and volatile memory.

In particular, the control of the spreading device of a spreading vehicle for winter road maintenance according to the present invention is not ensured based on global weather forecasts, but based on a combination of forecasts regarding weather and/or traffic route conditions provided via a remote server and surface parameters determined locally on recent positions by a device installed in the spreading vehicle. A spreading process of de-icing material on traffic routes, which is locally and temporally adapted accurately to the weather and/or road conditions (of the traffic routes) and which is not known in the state of the art, is thereby enabled.

The forecast data received by the server (and collected and/or determined by it in advance) from the data transmission device can be obtained on the basis of weather models related to locations that are evenly distributed in form of a local raster and/or data from meteorological stations and/or road ice warning systems. The server can determine data about traffic route conditions and/or weather conditions that are related to reference positions along a predetermined travel route of the spreading vehicle, which are distributed at relatively close distances from one another, and provide such data to the control unit of the spreading vehicle for control of the de-icing operation via the data transmission device.

According to a further embodiment, the data transmission device is configured to send data on the surface parameters determined by the device spreading vehicle for determining traffic route conditions installed in the spreading vehicle to the server, wherein the forecast data received by the server from the data transmission device are obtained on the basis of data about the defined surface parameters sent by the data transmission device to the server. Hence, the locally determined surface parameters become part of the forecast data that are provided by the server. For example, the server can send forecast data about future road conditions, on the basis of forecast data obtained otherwise and the data about the local surface parameters, to the data transmission device in the spreading vehicle so that the spreading operation of the de-icing device of the spreading vehicle can take place on the basis of these forecast data.

According to another further embodiment, the control unit is configured to calculate local forecast data about local weather and/or traffic route conditions related to the respective location of the spreading vehicle on the basis of the forecast data received by the server from the data transmission device and to control the spreading device on the basis of the calculated local forecast data. Hence, the control unit in this further embodiment can further process the data provided by the server. This further processing can in particular take place on the basis of the surface parameters determined by the device for determining traffic route conditions, which is installed in or on the spreading vehicle. Consequently, the control unit can be programmed flexibly for specific fields of application. For example, control units of different spreading vehicles can provide different controls of the de-icing operations in accordance with the region of use on the basis of the same data provided by the server.

In all examples described above for the device according to the invention, a further device for determining the air temperature and/or surface temperature of a traffic route and/or the melting point on the traffic route can be provided. This further device can be installed in or on the spreading vehicle and as part of the device for determining traffic route conditions, and the control unit can control the spreading device on the basis of the determined air temperature and/or surface temperature of a traffic route and/or of the melting point on the traffic route so that a further adaptation of the spreading process to local conditions can be enabled.

In all examples for the device according to the invention described above, the device for determining traffic route conditions can comprise:

a light transmission device that is configured for emitting light of predefined wavelengths onto a traffic route; and

a detection device that is configured to detect the light emitted by the light transmission device and reflected by the traffic route; and

a processing device that is configured to determine the surface parameters of the traffic route on the basis of the light detected by the detection device, in particular at least 100 times per second or at least 400 or 500 times per second.

The light transmission device can comprise an infrared transmission device that is configured to emit light of predetermined wavelengths onto a road surface, and it can be designed in form of an LED device. The processing device can be provided in form of a computer or comprise such a computer. Furthermore, the infrared transmission device can be configured to emit light of a predetermined wavelength in a wavelength range from 780 nm to 2500 nm, for example 780 nm to 1000 nm or 1500 nm.

Due to a high determination rate of the surface parameters of several hundred determinations per second, recent values of these parameters as well as changes of the parameters can be detected and evaluated as promptly as possible, i.e. practically without any noteworthy time lag. In case of 400 determinations per second, a measurement and determination will be conducted every 5 cm if the vehicle travels with a velocity of approximately 80 km/h. In principle, the determination of the surface parameters should be done so fast that the system can react very quickly and accurately to changes of the road conditions.

Furthermore, the device for determining traffic route conditions can comprise a pulse unit that is configured to pulse the light sent out by the infrared emitting device in pulses with a maximum duration of 500 μs, in particular of a maximum duration of 100 μs and/or pauses of a maximum duration of 500 μs, in particular of a maximum duration of 100 μs. The light required for the measurement can be emitted effectively and with low dead times through the pulses of the pulse unit. Further, a time constant, i.e. a clock, is provided by the pulsing process for the measurement and the subsequent determination.

In the device for determining traffic route conditions, the infrared transmission device can be configured to emit light of at least two predetermined wavelengths and/or from at least two different wavelength ranges (for detection of moist/wet vs. dry). The different wavelengths emitted by the infrared transmission device can be respectively in the infrared range, wherein the infrared transmission device can further emit light within a reference wavelength range for calibration, whereby the reference wavelength range is also in the infrared range.

One of the emitted wavelengths can in particular be suitable for the determination if ice or ice layers on the road, for example a wavelength of 1500 nm. A further emitted wavelength, which is different from the first wavelength, can be suitable for the determination of thin water films. In this context, a water film with a thickness up to approximately 1 mm can be determined on the road with a wavelength of 1450 nm. For thicker water films or water layers on the road, for example up to an approximate thickness of 30 mm, a further wavelength of approximately 980 nm can be used. In addition, a further wavelength of 1300 nm can be emitted permanently or periodically or at least at the start of the trip as a reference wavelength for the purpose of calibration. The mentioned three wavelengths as well as the reference wavelength are typically different from one another. It is clear that other wavelengths can also be used. The wavelengths can generally be adapted to the absorption bands of water and ice.

Moreover, a system to spread de-icing material on traffic routes is provided, which comprises a spreading vehicle for winter road maintenance, a device according to one of the preceding examples and a server in a wireless data connection with the data transmission unit of the device, wherein the server is configured to provide forecast data regarding weather and/or traffic route conditions. The server can be configured to provide the forecast data regarding weather and/or traffic route conditions as described above.

The problem mentioned above is also solved by a control method for the operation of a spreading device of a spreading vehicle for winter road maintenance according to claim 10. The method comprises the steps:

receiving of forecast data regarding weather and/or traffic route conditions that are provided by a server, in particular over the Internet and in particular by a data transmission device that is provided in the spreading vehicle;

determining of surface parameters of a traffic route by a device for determining traffic route conditions that is installed in or on the spreading vehicle; and

controlling the spreading device on the basis of the forecast data and defined surface parameters. A device for controlling the operation of a spreading device of a spreading vehicle for winter road maintenance according to each of the examples described above can be used for the control method. In particular, data about the specific surface parameters can be sent by the data transmission device to the server and after receipt of the data about the specific surface parameters, the server can calculate the forecast data on the basis of such data with regard to the locally determined surface parameters. On the other hand, it can also be provided that the control unit in the spreading vehicle creates local forecast data on the basis of the data received from the server and of locally determined surface parmeters and that it controls the de-icing operation on the basis of such local forecast data.

Determining the surface parameters of the traffic route can comprise the following steps: emission of light of predefined wavelengths, in particular in the infrared range, onto a traffic route, detection of the emitted light that is reflected by the traffic route and determination of the surface parameters on the basis of the detected light, in particular at least 100 times per second or at least 400 times per second.

Furthermore, a computer program product with one or multiple computer-readable media, which have computer-readable instructions that, when read by a computer, make such computer perform the steps on one of the examples of the method according to the invention described above, is provided.

Further features and exemplary embodiments of the present invention will be explained in greater detail based on the drawings in the following. It is clear that the embodiments are not exhaustive of the field of the present invention. It is further clear that some or all of the features described in the following can also be combined with one another in a different way.

### SHORT DESCRIPTION OF THE FIGURES

FIG. 1 shows an exemplary display of a system configuration with a server and a spreading vehicle with a data transmission device, a device for determining traffic route conditions and a control unit for controlling the operation of a spreading device of the spreading vehicle.

FIG. 2 illustrates an example for a device for determining traffic route conditions that is installed in or on a spreading vehicle.

### DETAILED DESCRIPTION

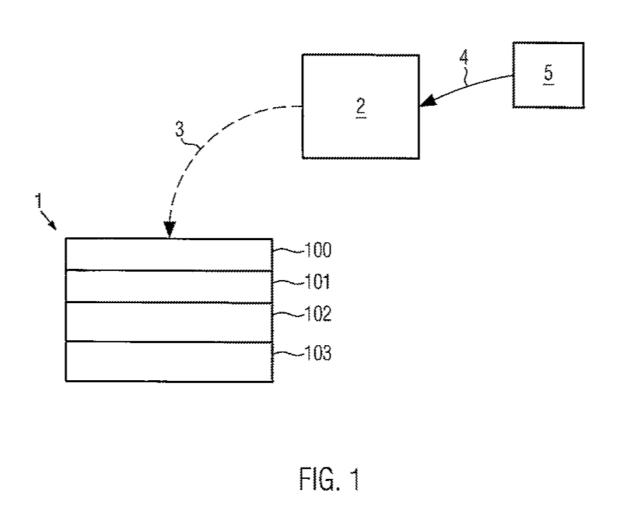

As shown in FIG. 1, a spreading vehicle 1 can be equipped with an example according to the invention of a device for controlling a spreading operation, wherein this device comprises a data transmission device 100, a device 101 for determining traffic route conditions and a control unit 102 for controlling the operation of a spreading device 103. By means of the data transmission device 100, data can be exchanged between the device and a server, for example an Internet (cloud) server 2 via a wireless data connection (Internet connection) 3. The Internet server 2 can, in turn, retrieve forecast data regarding weather and/or traffic route conditions via a data connection 4 from a database 5 or retrieve such data from the database 5 from which it can obtain forecast data regarding weather and/or traffic route conditions. In particular, the data are data on short-term forecasts regarding weather and/or traffic route conditions for a period of typically less than 12 hours, in particular less than 10 or 8 hours. For this purpose, the database 5 can provide global weather model data related to raster locations, for example from the Global Forecast System of the NTCEP in the 0.5° geo-raster. Alternatively or in addition, it can provide data of meteorological stations and/or road ice warning systems or data of road conditions and/or weather forecasts related to reference positions along a predetermined travel route of the spreading vehicle 1.

The Internet server 2 supplies data on (short-term) forecasts regarding weather and/or traffic route conditions to the data transmission device 100 of the spreading vehicle 1 that can comprise a mobile telephone or a tablet PC or another mobile computer device. On the basis of this data and locally by means of the device 101 for determining traffic route conditions of defined surface parameters of a road section of a traffic route that is (to be) accessed by the spreading vehicle, the operation of the spreading device 103 is controlled. These defined surface parameters comprise one or multiple parameters for the surface temperature, moisture, ice thickness, snow thickness, water film thickness, the ice-to-water ratio, the freezing temperature of an ice-water mixture, the salt content of an ice-water mixture and the friction coefficient. Hence, the control unit 102 can determine the optimal spreading density for the de-icing material (for example sand, gravel stones or de-icing salt) to be applied by the spreading device 103 for a road section recently entered and/or to be entered in the near future by means of a corresponding control model on the basis of the forecast data obtained by the Internet server 2 and the determined surface parameters. The determined and applied optimal spreading density guarantees that the treated road section will remain free of black ice at least for the time interval of the forecast data.

The spreading operation of the spreading device 103 can be controlled in a very locally accurate way through the combination of processing the forecast data provided by the Internet server 2 and the locally determined surface parameters. For example, an automated preventive spreading of de-icing material can take place on a bridge that is dry and cold while being entered by the spreading vehicle 1 and on which for instance snowfall or glazed frost can be expected within the next 2 hours, whereas road sections along the travel route of the spreading vehicle 1 immediately before and after the bridge will not be covered with de-icing material.

According to an embodiment, it is provided for the Internet server 2 to contain data about the surface parameters determined by the device 101 to identify traffic route conditions and to take into account such data in determining forecast data regarding traffic route conditions that will finally be provided to the control unit 102 via the data transmission device 100 and the data connection 3. According to an embodiment, it is provided for the control unit 102 to use the forecast data received from the Internet server 2 in consideration of the surface parameters, determined by the device 101 to specify traffic route conditions, to determine local forecast data regarding traffic route conditions, which will then be used to control the spreading device 103.

In the examples mentioned above, the surface parameters can also be complemented by data regarding the air temperature and/or surface temperature of a traffic route and/or of the melting point on the traffic route of the spreading vehicle 1, which are provided by a respective device installed in or on the spreading vehicle 1. Also on the basis of such data, the Internet server 2 and/or the control unit 102 of the spreading vehicle 1 can obtain forecast data regarding weather and/or traffic route conditions for controlling the spreading device 103.

In the examples mentioned above, the data transfer from the Internet server 2 to the data transmission device 100 of the spreading vehicle 1 and/or vice versa can take place continuously automatically or in predefined time intervals.

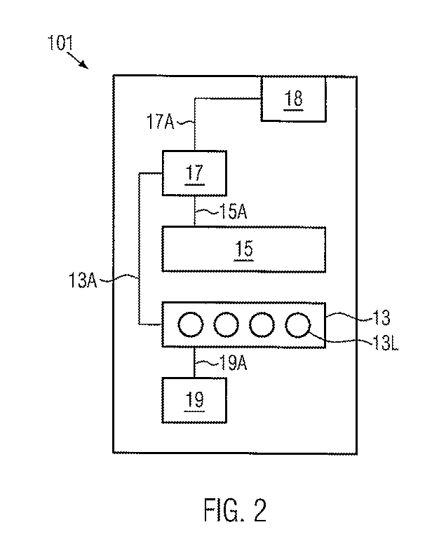

A device 101 for determining traffic route conditions is illustrated in FIG. 2. FIG. 3 schematically displays a front view of the device 101 for determining traffic route conditions from FIG. 1. In the embodiment shown in FIG. 2, the device 101 comprises an LED unit 13. The LED unit 13 in FIG. 3 is shown—in a purely exemplary way—with four LED 13L. There can also be another number of LED in the LED unit 13. However, the number of four LED 13L has the advantage that each LED 13L can assume a different function. Typically, the LEDs 13L can emit light in the infrared range. Other wavelengths are also possible in principle. Light in the infrared range is on one hand invisible for other road users and on the other hand particularly suitable for the detection of water layers and ice layers, in particular on road surfaces. One of the wavelengths emitted by the LEDs 13L of the LED unit 13 can be suitable for identifying ice or ice layers on the road, for example a wavelength of 1500 nm. A second LED 13L can emit a wavelength that differs from the first wavelength and that can be particularly suitable for determining thin water films. In this context, a water film of for example up to a thickness of 1 mm can be determined on the road with a wavelength of 1450 nm. For thicker water films or water layers on the road, approximately up to a water layer thickness of 30 mm, a further wavelength can be used with another LED. In particular, this further wavelength can be approximately 980 nm. In addition, a further wavelength of 1300 nm can be emitted by means of a fourth LED 13L continuously or periodically or at least at the beginning of the trip. This further wavelength can be used as a reference wavelength for calibration. It is clear that other wavelengths can also be used. Likewise, more than four LEDs can be used as well.

The LED unit 13 can be controlled via a pulse unit 19. The pulse unit 19 can be connected to the LED unit through a line 19A. The light emitted by the LED unit can be pulsed by the pulse unit in pulses with a maximum duration of 500 ps, in particular with a maximum duration of 100 μs and/or pauses with a maximum duration of 500 μs, in particular with a maximum duration of 100 μs.

By means of the LEDs 13L, the LED unit 13 emits light onto the road surface and is reflected there. FIG. 2 further shows a detection device 17, for example a sensor unit, for detecting the light that is emitted by the LED device 13 and subsequently reflected by the road surface. The detection unit 17 can typically receive information about the light emitted by the LEDs 13L and, where required, its pulse via a line 13. The detection unit 17 can further process the received analog light information of the reflected light. For example, the detection unit 17 on the spreading vehicle 1 of FIG. 1 can detect the light sent out by the LED unit 13 and reflected by the road surface at least 1.0 meters above the road surface. The device 101 for determining traffic route conditions can be configured in a way as to determine the surface parameters on the basis of the detected light, in particular at least 100 times per second or at least 400 times per second.

The detection unit 17 can be connected to a line 17A with an interface 18. The interface 18 can comprise a CAN interface or another interface that is typical for passenger cars so that the signals provided by the detection unit 17 can be further processed.

In the embodiments above, a LED device/unit is used as an infrared emission device. This shall be understood as an example; alternatively, other suitable infrared emission devices can be used as well.

Hence, a device for controlling the operation of a spreading device of a spreading vehicle for winter road maintenance is provided, which enables reliable spreading to prevent the formation of black ice on traffic routes by taking into account forecast data, which are provided by a remote server, and locally determined surface parameters.

1. A device for controlling the operation of a spreading device (103) of a spreading vehicle for winter road maintenance with
a data transmission device that is provided in the spreading vehicle and that is configured to establish a wireless data connection and that is configured to receive forecast data regarding weather and/or traffic route conditions from a server, in particular over the Internet;
a device for determining traffic route conditions that is installed in or on the spreading vehicle and configured to determine surface parameters of a traffic route; and
a control unit that is configured to receive and to process the forecast data from the data transmission device and to control the operation of the spreading device on the basis of the processed forecast data and the determined surface parameters.

2. The device according to claim 1, wherein the data transmission device is configured to send data regarding the specific surface parameters to the server, and wherein the forecast data received by the server from the data transmission device is obtained on the basis of the data regarding the specific surface parameters sent to the server by the data transmission device.

3. The device according to claim 1, wherein the forecast data received by the server from the data transmission device is obtained on the basis of weather models and/or data from meteorological stations and/or road ice warning systems related to raster locations that are evenly locally distributed.

4. The device according to claim 3, wherein the forecast data is calculated for reference positions along a predetermined travel route of the spreading vehicle.

5. The device according to claim 1, wherein the control unit is configured to calculate local forecast data regarding local weather and/or traffic route conditions, which refer to the respective location of the spreading vehicle, on the basis of the of the forecast data received by the server from the data transmission device and to control the spreading device based on the calculated local forecast data.

6. The device according to claim 1, wherein the surface parameters comprise one or several parameters for the surface temperature, moisture, ice thickness, snow thickness, water film thickness, the ice-to-water ratio, the freezing temperature of an ice-water mixture, the salt content of an ice-water-mixture and the friction coefficient.

7. The device according to claim 1, further with a unit for determining the air temperature and/or surface temperature of a traffic route and/or the melting point on the traffic route, whereby the unit is installed in or on the spreading vehicle and wherein the control unit controls the spreading device on the basis of the determined air temperature and/or surface temperature of the traffic route and/or of the melting point on the traffic route.

8. The device according to claim 1 in which the device for determining traffic route conditions contains:
a light transmission device that is configured for emitting light of predefined wavelengths onto a traffic route;
a detection device that is configured to detect the light emitted by the light transmission device and reflected by the traffic route; and
a processing device that is configured to determine the surface parameters of the traffic route on the basis of the light detected by the detection device, in particular at least 100 times per second or at least 400 times per second.

9. A system for spreading de-icing material on traffic routes, with
a spreading vehicle for winter road maintenance;
a device according to one of the preceding claims; and
a server in a wireless data connection with the data transmission device of the device, wherein the server is configured to provide forecast data regarding weather and/or traffic road conditions.

10. A control method for the operation of a spreading device of a spreading vehicle for winter road maintenance with the steps:
receiving of forecast data regarding weather and/or traffic route conditions that are provided by the server, in particular over the Internet and in particular through a data transmission device that is provided in the spreading vehicle;
determining of surface parameters of a traffic route by a device for determining traffic route conditions that is installed in or on the spreading vehicle; and
controlling of the spreading device on the basis of the forecast data and the determined surface parameters.

11. The method according to claim 10, further with submission of data regarding the determined surface parameters to the server by the data transmission device and receiving the data regarding the determined surface parameters and identifying the forecast data on the basis of such data by the server.

12. The method according to claim 10, with calculation of local forecast data regarding weather and/or traffic route conditions by the control unit installed in the spreading vehicle on the basis of forecast data regarding weather and/or traffic route conditions provided by the server and the determined surface parameters of the traffic route.

13. The method according to claim 10 in which determining the surface parameters of the traffic route comprises the steps:
emitting light of predetermined wavelengths, in particular in the infrared range, onto a traffic route;
detecting the light that has been emitted and reflected by the traffic route; and
determining the surface parameters on the basis of the detected light, in particular at least 100 times per second or at least 400 or 500 times per second.

14. A computer program product embodied on a non-transitory computer-readable medium for the operation of a spreading device of a spreading vehicle for winter road maintenance, the computer program product comprising a computer-readable storage medium having computer-readable program code portions stored therein, the computer-readable program code portions comprising:
an executable portion configured for receiving of forecast data regarding weather and/or traffic route conditions that are provided by the server, in particular over the Internet and in particular through a data transmission device that is provided in the spreading vehicle;
an executable portion configured for determining of surface parameters of a traffic route by a device for determining traffic route conditions that is installed in or on the spreading vehicle; and
an executable portion configured for controlling of the spreading device on the basis of the forecast data and the determined surface parameters.

15. A method according to claim 11, with calculation of local forecast data regarding weather and/or traffic route conditions by the control unit installed in the spreading vehicle on the basis of forecast data regarding weather and/or traffic route conditions provided by the server and the determined surface parameters of the traffic route.

16. A method according to claim 11 in which determining the surface parameters of the traffic route comprises the steps:
emitting light of predetermined wavelengths, in particular in the infrared range, onto a traffic route;
detecting the light that has been emitted and reflected by the traffic route; and
determining the surface parameters on the basis of the detected light, in particular at least 100 times per second or at least 400 or 500 times per second.

17. A method according to claim 12 in which determining the surface parameters of the traffic route comprises the steps:
emitting light of predetermined wavelengths, in particular in the infrared range, onto a traffic route;
detecting the light that has been emitted and reflected by the traffic route; and
determining the surface parameters on the basis of the detected light, in particular at least 100 times per second or at least 400 or 500 times per second.

18. A computer program product according to claim 14, the computer-readable program code portions comprising:
an executable portion configured for receiving data regarding the determined surface parameters and identifying the forecast data on the basis of such data by the server.

19. A computer program product according to claim 14, the computer-readable program code portions comprising:
an executable portion configured for calculating the local forecast data regarding weather and/or traffic route conditions by the control unit installed in the spreading vehicle on the basis of forecast data regarding weather and/or traffic route conditions provided by the server and the determined surface parameters of the traffic route.

20. A computer program product according to claim 14, the computer-readable program code portions comprising:
an executable portion configured for emitting light of predetermined wavelengths, in particular in the infrared range, onto a traffic route;
an executable portion configured for detecting the light that has been emitted and reflected by the traffic route; and
an executable portion configured for determining the surface parameters on the basis of the detected light, in particular at least 100 times per second or at least 400 or 500 times per second.
